(19) United States
(12) Patent Application Publication
(10) Pub. No.: US 2003/0101565 A1
(43) Pub. Date: Jun. 5, 2003

(54) Pedestal jacking device and advanced drive for solar collector system

(76) Inventor: Barry L. Butler, Solana Beach, CA (US)

Correspondence Address: KILPATRICK STOCKTON LLP, 607 14TH STREET, N.W., SUITE 900, WASHINGTON, DC, 20005, US

(21) Appl. No.: 09/998,857

(22) Filed: Nov. 30, 2001

(51) Int. Cl. B23P 11/00

(52) U.S. Cl. 29/428

(57) ABSTRACT

A system and method for deploying a solar collector system comprising a solar collector, pedestal, pedestal jacking device, and advanced drive unit is described. The advanced drive unit is capable of erecting the pedestal over a preformed mounting area. The pedestal jacking device lowers the pedestal into the mounting area. After the pedestal has been secured, the pedestal jacking device may be used to raise the solar collector and the advanced drive, which includes azimuth and elevation drive sub-assemblies, from the ground level to the operational level, near the top of the pedestal. The advanced drive unit is used to track the movement if the sun and position the solar collector in optimum position for receiving light rays from the sun. The pedestal jacking device may be used to lower the solar collector and the advanced drive unit if repair to either one is needed.

### FIELD OF THE INVENTION

The embodiments of the invention relate in general to drive systems, and more particularly to a system and method for deploying a solar collector system including a pedestal jacking device and an advanced drive mechanism.

### BACKGROUND OF THE INVENTION

Solar power is becoming an increasingly important energy source. In third world countries, where other energy producing resources may be scarce, solar power may provide the only cost effective way to meet energy demands. Solar power has become a significant energy source even in more economically developed nations.

Solar energy technologies convert the sun's light into usable electricity. Electricity is often produced by solar energy systems using photovoltaic cells or other devices such as a stirling engine or concentrating photovoltaic generator. Solar energy systems have no fuel costs. Another advantage of solar energy systems is that solar power is an environmentally clean way to generate electricity. There are no emissions associated with the conversion of the sun's light to usable electricity. Other types of devices such as a stirling engine can be used to produce electricity from solar energy. A stirling engine is a unique heat engine in which the theoretical efficiency is nearly equal to the theoretical maximum efficiency, known as the Carnot Cycle efficiency (between approximately 39% for metal heater heads and approximately 50% for ceramic heater heads). A stirling engine is powered by the expansion of a gas when heated, followed by the compression of the gas when cooled. A stirling engine contains a fixed amount of gas which is transferred back and forth between a “cold” end (often room temperature) and a “hot” end (sometimes heated by a kerosene or alcohol burner). A “displacer piston” moves the gas between the two ends and a “power piston” changes the internal volume as the gas expands and contracts. A concentrator photovoltaic cell is a space power cell having efficiencies greater than approximately 30% at 500 suns concentration, but having no moving parts, and are generally more reliable than other systems.

Solar energy systems typically provide a pedestal, preferably ten to thirty feet tall, for supporting an array of solar panels or collectors. A drive unit is mounted at the top of the pedestal to move the solar collector so that it constantly faces the sun by compensating for the earth's daily rotation as well as the earth's seasonal orbit around the sun. Solar power production is most efficient when the solar collector is oriented favorably, depending on the geometry of the collector, to the incoming light rays from the sun. For a flat solar collector, this geometry is most favorable when the sun's rays are perpendicular to the collector.

Existing solar collector tracking systems require assembly of the solar collector on the ground near the pedestal, the drive unit is bolted to the collector and ready to be mounted to the top of the pedestal. The concentrator is then lifted by crane or other heavy machinery and the drive is bolted to the top of the pedestal. This operation may be difficult and dangerous in winds exceeding five miles per hour, requiring unwanted delay in deployment. Additionally, in many places, cranes or other such machinery may not be readily available. Even if available, the use of a crane to deploy the solar collector may add significantly to the cost of the system.

Difficulties may arise if repair is necessary to the solar collector and/or drive unit, again requiring a crane to lower the solar collector or drive unit from the pedestal. Wind and hale are common causes of damage to solar collectors.

Solar tracking systems typically employ two independent drives in order to tilt the collector about two axes. One axis is the elevation axis and the other is the azimuth axis. The required range of angular rotation may depend on the earth's latitude at which the solar collector is installed.

Previous solar collector systems may not be properly mass balanced. This increases the energy requirement when the drive units are operated to track the sun. The imbalance increases the torque requirement for turning the solar collector as compared to a balanced system. The increased torque requirement translates into increased energy requirements for operating these systems.

Conventional drives for solar collectors are costly to manufacture. This is due to complex linkages and expensive gearing necessary to handle the expected loads, including the operating and survival wind loads, and the weight and rotation of a solar collector. These types of conventional drives are not easily maintained or deployed in remote locations, thus are cumbersome to use with solar collectors deployed in these areas.

Therefore, there is a need to provide a system and method for mounting and raising a solar collector system without the need for a crane or other heavy machinery.

Furthermore, there is a need to provide a system and method for erecting a pedestal using the azimuth/elevation drive apparatus and the pedestal jacking device.

There is yet a further need to provide a system and method for mounting and raising a solar collector system while minimizing or eliminating joints near the central portion of the elevation torque shaft where moments and stresses can be relatively high.

Moreover, there is a need to provide a pedestal jacking device capable of elevating the solar collector and azimuth/elevation drive apparatus from the ground level to the operational level without the need for a crane or other heavy machinery.

There is yet a further need to provide a hydraulic jacking device capable of elevating the solar collector and azimuth/elevation drive apparatus from the ground level to the operational level without the need for a crane or other heavy machinery.

Still there is a further need to provide a threaded screw jacking device capable of elevating the solar collector and azimuth/elevation drive apparatus from the ground level to the operational level without the need for a crane or other heavy machinery.

There exists yet another need to provide a pedestal jacking device capable of elevating the solar collector and azimuth/elevation drive apparatus from the ground level to the operational level in winds greater than five miles per hour.

There is yet another need to provide an azimuth/elevation drive apparatus that is mass balanced, reducing torque requirements when tracking the sun and when moving to a face down stow position for nighttime storage or engine repair.

Furthermore, there is another need to provide a system and method for easy lowering of the solar collector and azimuth/elevation drive apparatus if needed for repair purposes without the need for a crane or other heavy machinery.

Finally, there is a need to provide a system and method for deploying a solar collector on a pedestal using a drive that does not require complex linkages or expensive gearing.

### SUMMARY OF THE INVENTION

The embodiments of the invention solve the above needs and significant problems in the art by providing a system and method for raising a solar collector and azimuth/elevation drive apparatus at the top of a pedestal, without the use of a crane or other heavy machinery.

Generally described, the embodiments of the invention provide a system for elevating a pedestal so that it is mounted in substantially vertical orientation, raising a solar collector and azimuth/elevation drive apparatus from the ground level to operational level near the top of the pedestal, and rotating the solar collector to a position for optimal reception of sun light.

The embodiments of the invention provide a pedestal jacking device for raising the solar collector and azimuth/elevation drive apparatus from the ground level to an operational level, typically at the top of the pedestal. The azimuth/elevation drive apparatus comprises an azimuth drive sub-assembly and an elevation drive sub-assembly. The azimuth drive sub-assembly comprises a gear ratio capable of handling a high moment caused by rotation of the solar collector on the pedestal. The azimuth/elevation drive apparatus comprises an azimuth drive gear connected to the solar collector that is configured to rotate the solar collector around an axis that is collinear with a substantially vertical axis of the pedestal. An azimuth worm gear transmits power from an associated motor to the azimuth drive gear.

The elevation drive sub-assembly comprises a gear ratio capable of rotating the solar collector from a face-down position through to a face-up position while the solar collector is near the top of the pedestal. The elevation drive subassembly comprises an elevation drive gear connected to the solar collector that is configured to rotate the solar collector from a face-down position through to a face-up position. An elevation worm gear transmits power from an associated motor to the elevation drive gear.

A pedestal jacking device for raising the solar collector and azimuth/elevation drive apparatus may be a hydraulic lifting device. The hydraulic lifting device comprises a first collar and a second collar connected to the pedestal, the first collar and the second collar connected by at least one hydraulic cylinder. A clamp is provided on each collar for opening and closing the collar using a hydraulic cylinder. A hydraulic motor provides power to the hydraulic cylinders allowing the pedestal jacking device to elevate and lower the solar collector and the azimuth/elevation drive apparatus. The first collar is clamped to the pedestal while the second collar is raised by the hydraulic cylinders. The second collar is clamped to the pedestal while the first collar is raised by the hydraulic cylinders.

Alternatively, the pedestal jacking device may comprise at least two threaded rods connected to an azimuth collar. The threaded rods each engage a nut adjacent to the top of the pedestal. An electric motor turns the nuts, elevating the solar collector and azimuth/elevation drive apparatus. The motor is reversible to also lower the azimuth/elevation drive apparatus.

The embodiments of the invention also provide a system and method for deploying a solar collector, pedestal, pedestal jacking device, and azimuth/elevation drive apparatus without the use of a crane or other heavy machinery. The azimuth/elevation drive apparatus of the embodiments of the invention is capable of rotating the pedestal from a substantially horizontal position to a substantially vertical position for mounting. The azimuth/elevation drive apparatus is used to rotate the pedestal above the mounting area, and the pedestal jacking device is used to lower the pedestal into the mounting area.

The combination of the jacking device, azimuth/elevation drive apparatus, and pedestal stabilize the solar collector during lifting so that relatively low winds will not cause the collector to swing or sway dangerously. Furthermore, the combination of the jacking device, azimuth/elevation drive apparatus, and pedestal permit the solar collector to be lifted into position at the top of the pedestal so that it can be secured into place.

In at least one embodiment of the invention, the elevation torque shaft can be offset during lifting of the collector relative to the pedestal. The elevation torque shaft can then be moved over and centered above the pedestal, once the azimuth/elevation drive apparatus has reached a position near the top of the pedestal. In this embodiment, the elevation torque shaft has minimal or no joints near the center portion of the shaft where moments and stresses can be relatively high.

Other features, and advantages of the embodiments of the invention will become apparent upon reading the following detailed description of embodiments of the invention, when taken in conjunction with the accompanying drawings and appended claims.

### BRIEF DESCRIPTION OF THE DRAWINGS

FIG. 1 illustrates an exemplary embodiment of a system according to the invention.

FIGS. 1a-1b illustrate exemplary embodiments of the system shown in FIG. 1.

FIGS. 2-14 illustrate an exemplary embodiment of a method according to the invention.

FIG. 15 illustrates a perspective view of an exemplary embodiment of a pedestal jacking device according to the invention.

FIG. 16 illustrates a perspective view of an exemplary embodiment of the pedestal jacking device shown in FIG. 15.

FIG. 17 illustrates another perspective view of an exemplary embodiment of the pedestal jacking device shown in FIG. 15.

FIG. 18 illustrates a perspective view of another embodiment of a pedestal jacking device according to the invention.

FIG. 19 is a perspective view of an exemplary embodiment of an azimuth/elevation drive apparatus according to the invention.

FIG. 20 is another perspective view of the invention shown in FIG. 19.

FIG. 21 is an exploded view of the invention shown in 1G. 19.

FIG. 22 is another exploded view of the invention shown in FIG. 19.

### DETAILED DESCRIPTION OF EMBODIMENTS OF THE INVENTION

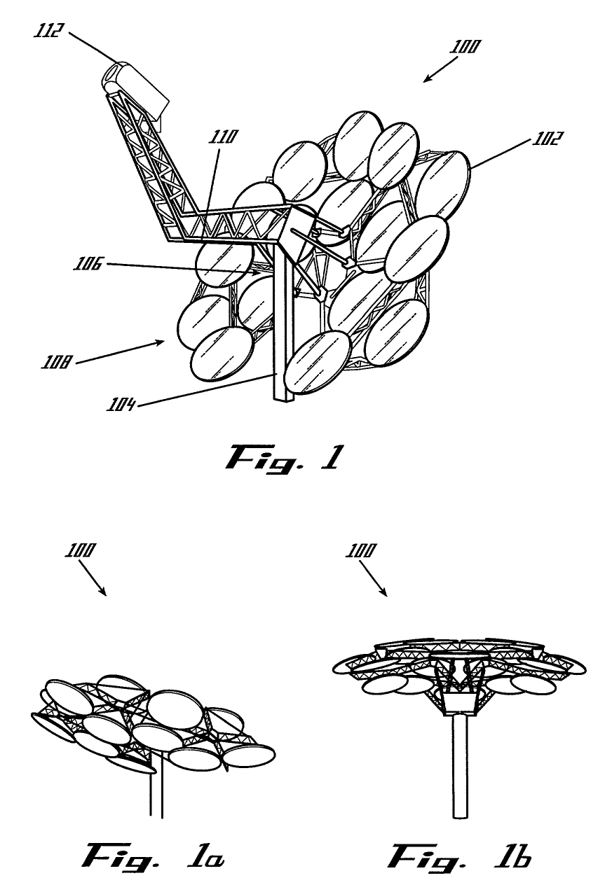

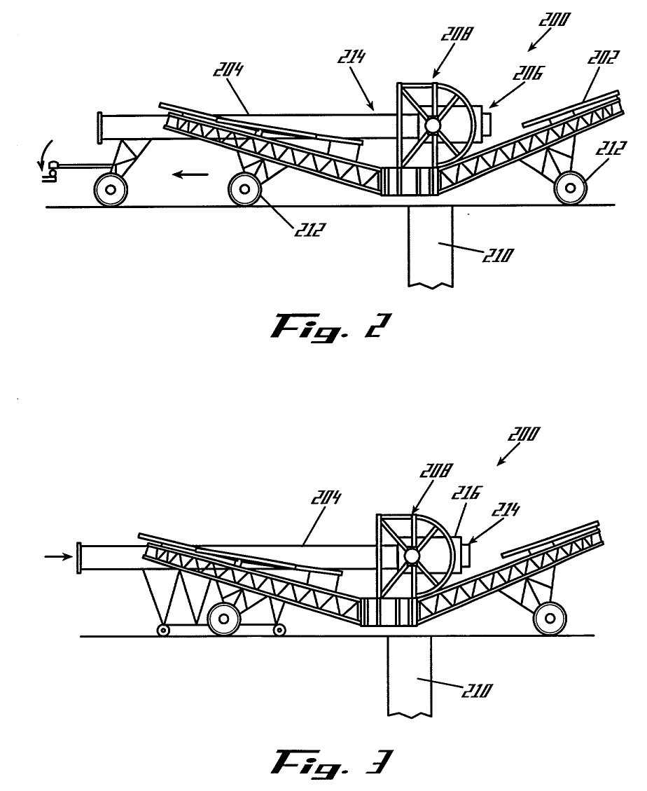

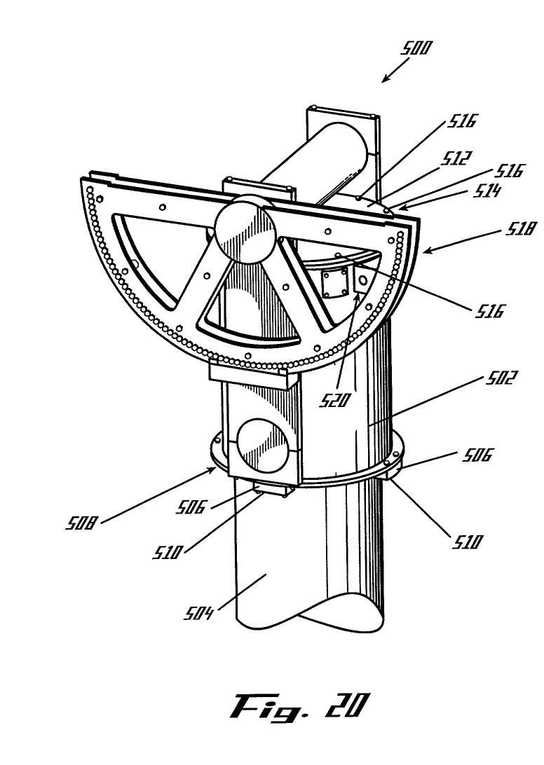

Particular embodiments of the invention will now be described in greater detail with reference to the drawings. FIG. 1 illustrates an exemplary embodiment of a system according to the invention. FIG. 11a illustrates the embodiment of FIG. 1 in a face up position without a power conversion support arm. FIG. 1b illustrates the embodiment of FIG. 1 in a face down stow position without a power conversion support arm. FIGS. 2-14 illustrate an exemplary embodiment of a method according to the invention. FIGS. 15-17 illustrate an exemplary embodiment of a pedestal jacking device according to the invention. FIG. 18 illustrates another embodiment of a pedestal jacking device according to the invention. FIGS. 19-22 illustrate an exemplary embodiment of an azimuth/elevation drive apparatus according to the embodiments of the invention.

Solar Collector System

FIG. 1 illustrates an exemplary embodiment of a system according to the invention. A solar collector system 100 is shown in a deployed position. The solar collector system includes a solar collector 102, pedestal 104, pedestal jacking device 106, azimuth/elevation drive apparatus 108, a power conversion support arm 110, and a stirling engine/generator 112.

When deployed, the solar collector system 100 generates usable electrical power by converting collected solar energy radiated from the sun. In this example, a solar collector 102 is configured upon a pedestal 104. A pedestal jacking device 106 and azimuth/elevation drive apparatus 108 cooperate to elevate the solar collector 102 on the pedestal 104. FIG. 1a illustrates the solar collector 102 in a face-up position at the top of the pedestal 104 without the power conversion support arm. The azimuth/elevation drive apparatus 108 can then rotate the solar collector 102 to a position to connect the power conversion support arm 110. Once the power conversion support arm 110 is connected to the solar collector 102, then the solar collector 102 on the pedestal 104 can be rotated to an operational position as shown in FIG. 1. In the operational position, the solar collector 102 focuses reflected solar energy onto the stirling engine/generator 112 mounted on the extended power conversion support arm 110. The stirling engine/generator 112 then converts the received solar energy to usable electrical power.

When not in use, the solar collector system 100 can be stowed away to protect the solar collector 102 from adverse elements such as rain, hail, wind, debris, etc. The stirling engine/generator 112 mounts on the extended power conversion support arm 110 and the assembly can be disconnected from the solar collector 102 so that the azimuth/elevation drive apparatus 108 can rotate the solar collector 102 to face downward towards the ground. FIG. 1b illustrates the solar collector 102 in a face-down or stowed position without the power conversion support arm. Moreover, the solar collector system 100 can be disassembled and reassembled into individual component parts 102-112 in a relatively short time without the use of heavy lifting equipment. The following series of figures illustrates a deployment of a solar collector system 100.

Deployment of a Solar Collector System

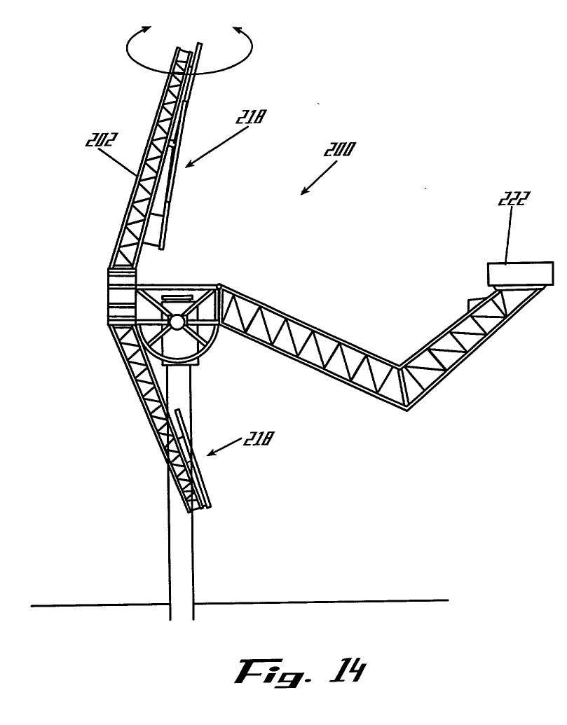

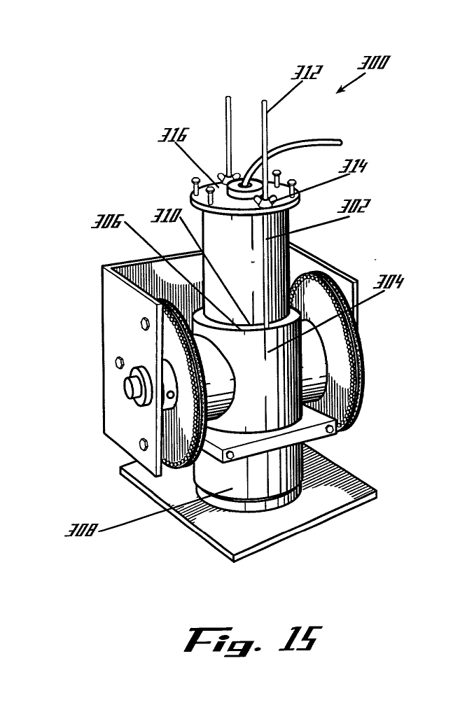

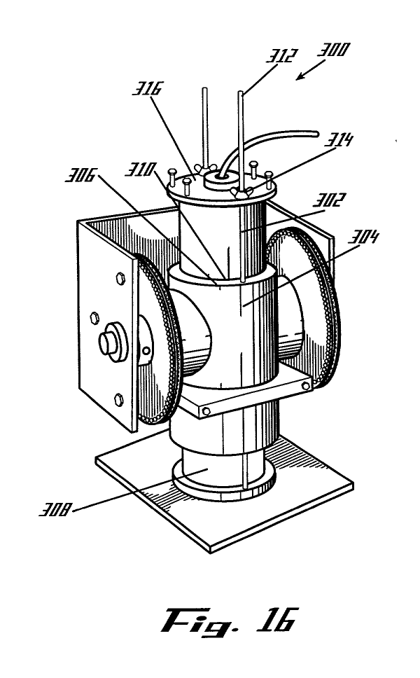

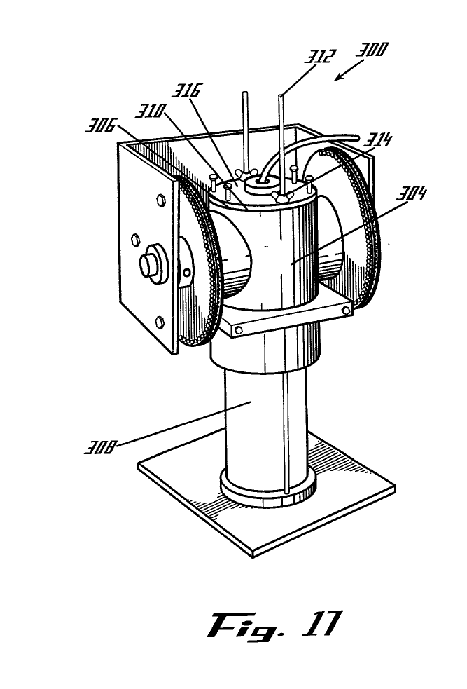

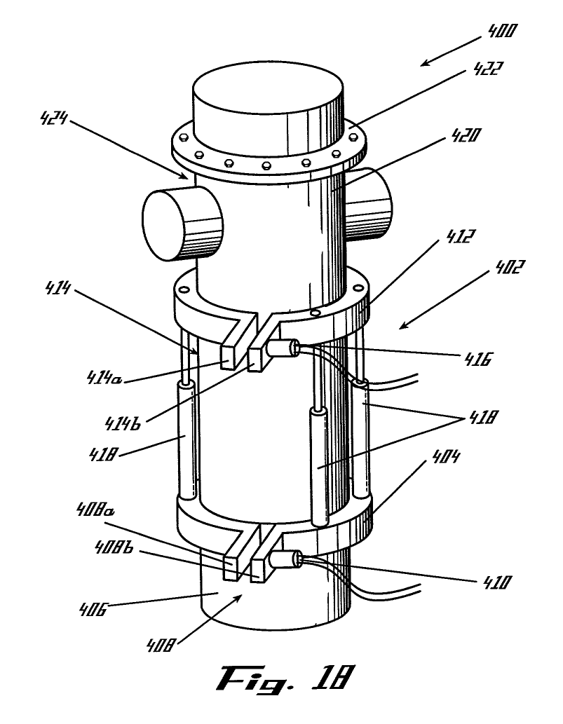

FIGS. 2-14 illustrate an exemplary embodiment of a method according to the invention. In the following series of illustrations, a method for deploying a solar collector on a pedestal is shown. In particular frames of the series, the solar collector system is shown in stowed and operational positions, for example, FIG. 12 shows the solar collector system in a stowed position, and FIG. 14 shows the solar collector system 200 in an operational position.

FIG. 2 illustrates a pre-deployment position of a solar collector system 200. The solar collector system 200 includes a solar collector 202, a pedestal 204, pedestal jacking device 206, azimuth/elevation drive apparatus 208, a power conversion support arm (not shown), and a stirling engine/generator (not shown). The solar collector system 200 is configured for installation at a solar collection/power generating site. Typically, a few component parts of the solar collector system 200 can be preassembled at an adjacent or remote assembly location. For example, the solar collector 202, pedestal jacking device 206, and azimuth/elevation drive apparatus 208 can be connected together and further configured to readily mount to the pedestal 204 at the installation site. Furthermore, the power conversion support arm, and a stirling engine/generator or concentrating photovoltaic generator can be connected together and further configured to readily mount to the solar collector 202 at the installation site.

In FIG. 2, a solar collector system 200 is shown positioned over a mount 210 such as a predrilled foundation or hole at an installation site. In this example, the mount 210 is a hole. Associated wheels 212 can be installed or connected to component parts of the solar collector system 200 to transport component parts of the solar collector system 200 to the mount 210 or installation site. Alternatively, the solar collector system 200 can be loaded onto a trailer (not shown) or similar type of transport device for transporting the solar collector system 200 to the mount 210. In either instance, the solar collector system 200 can be transported in a relatively horizontal, face up position from an assembly location to the area of the mount 210.

A mount 210 can be a predrilled foundation or hole provided for the mounting of the solar collector 202. The hole can be predrilled or excavated to receive the base end 214 or lower portion of the pedestal 204. Alternatively, a predrilled foundation can be a concrete pad with a series of holes sized to receive a series of mounting bolts. The mounting bolts are sized to fit corresponding holes in the base end 214 of the pedestal 204. In either case, the predrilled foundation or hole is configured to receive the base end 214 of the pedestal 204, and is further configured to support the solar collector system 200 in a substantially vertical or upright position above the ground.

In some cases, the solar collector system 200 may be fully assembled and transported in a substantially vertical or upright position to the area of the mount 210. However, insufficient overhead clearance between a solar collector system 200 in an upright position and overhead objects may hinder or prevent transport of the solar collector system 200 in a vertical or upright position.

FIG. 3 illustrates the insertion of the pedestal 204 into an azimuth collar 216 connected to the azimuth/elevation drive apparatus 208. As described previously, the pedestal 204 has a base end 214 or lower portion. The azimuth/elevation drive apparatus 208 connects to an azimuth collar 216. The azimuth collar 216 is sized to receive the base end 214 or lower portion of the pedestal 204. In FIG. 3, the base end 214 or lower portion of the pedestal 204 is shown being inserted into the top portion of the azimuth collar 216 connected to the azimuth/elevation drive apparatus 208. The base end 214 or lower portion of the pedestal 204 is then further inserted through the azimuth collar 216 until the base end 214 or lower portion of the pedestal 204 protrudes through the bottom portion of the azimuth collar 216. Alternatively, the solar collector system 200 can be preassembled at an assembly location with the pedestal 204 already inserted through the azimuth collar 216. In that case, the solar collector system 204 can then be transported to the installation site including a mount 210 such as a predrilled foundation or hole.

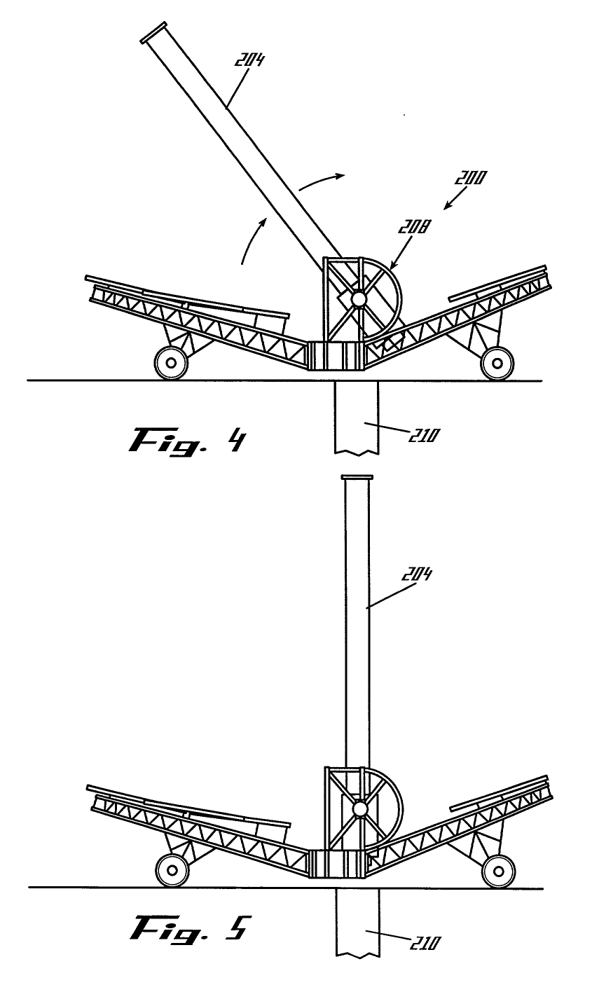

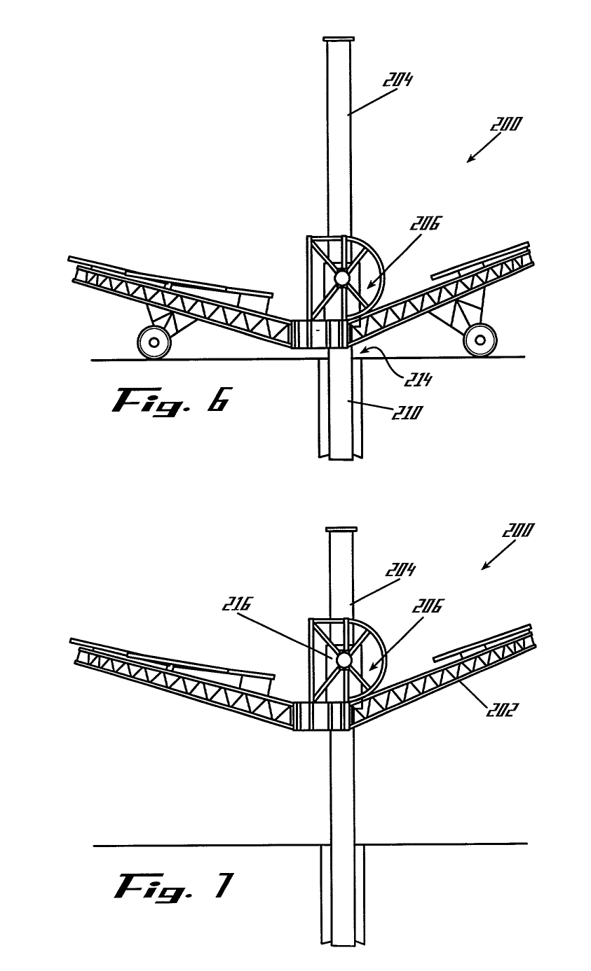

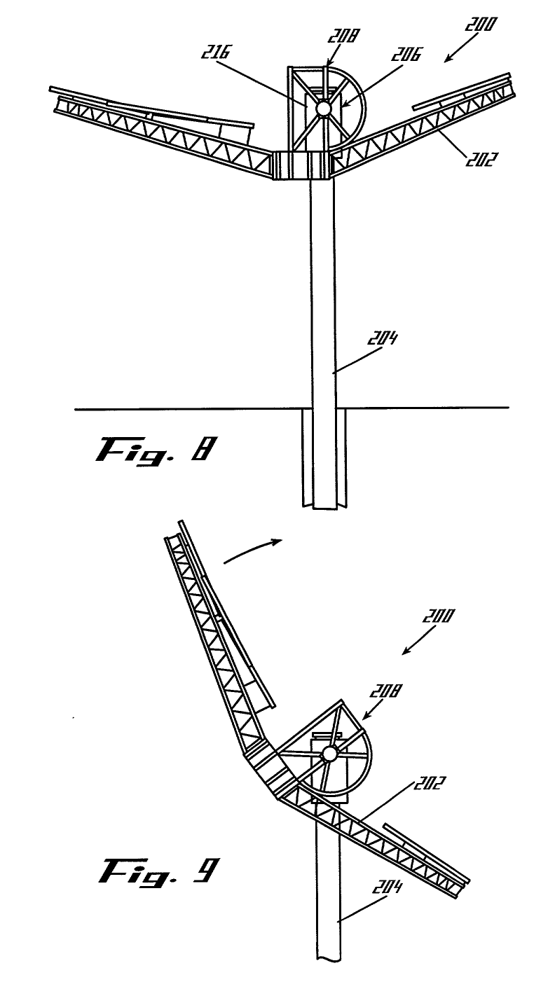

FIG. 4 illustrates the erection of the pedestal 204. In FIG. 4, the azimuth/elevation drive apparatus 208 rotates the pedestal 204 from a substantially horizontal position to a substantially vertical or upright position over the mount 210, shown here as a hole.

FIG. 5 shows the pedestal 204 in a substantially vertical or upright position immediately above the mount 210, shown here as a hole.

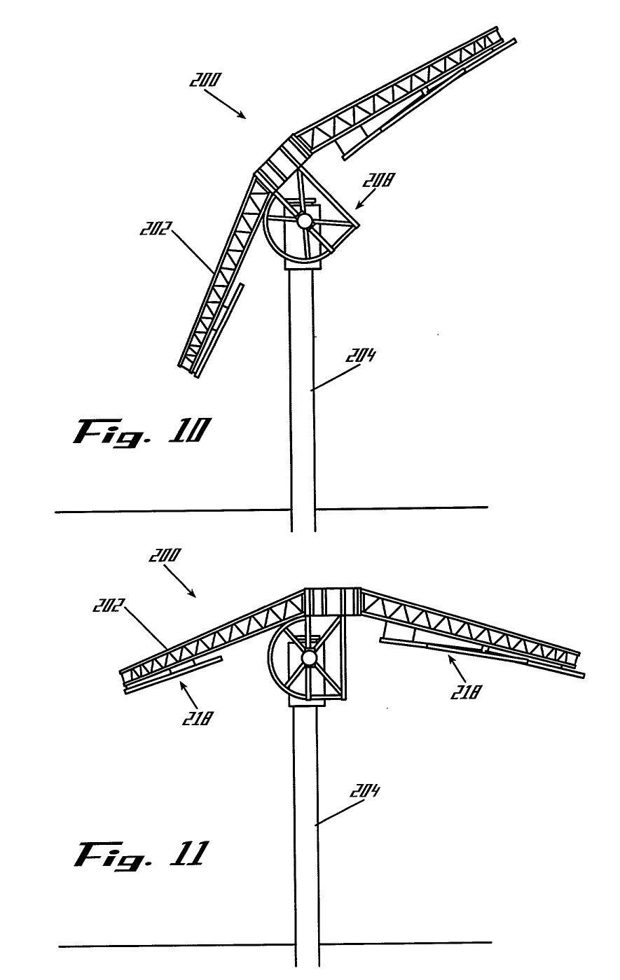

FIG. 6 illustrates the pedestal 204 being lowered towards the mount 210. Once the pedestal 204 is elevated from a substantially horizontal position to a substantially vertical or upright position above the mount 210, the pedestal jacking device 206 as explained below, lowers the pedestal 204 towards the mount 210. As shown here, the pedestal 204 is lowered into a previously excavated hole. In this case, premixed concrete (not shown) can then be filled around the pedestal 204 within the hole, and then the concrete is allowed to set and cure so that the pedestal is supported within the predrilled hole.

In the case of the mount 210 being a predrilled foundation, the pedestal 204 can be lowered upon the foundation by the pedestal jacking device 206. Corresponding bolt holes in the base end 214 of the pedestal 204 can then be aligned to match a series of bolt holes in the predrilled foundation. Foundation bolts can then be inserted through bolt holes in the base end 214 of the pedestal 204 and then tightened into the bolt holes in the predrilled foundation. The foundation bolts secure the pedestal 204 to the predrilled foundation in a substantially vertical or upright position.

FIG. 7 shows the pedestal jacking device 206 lifting the solar collector 202 upward with respect to the pedestal 204. That is, when the pedestal jacking device 206 is activated, the solar collector 202 can be elevated with the azimuth collar 216 from the lower portion of the pedestal 204 towards the top portion of the pedestal 204. Typically, the solar collector 202 is in a substantially horizontal, face up position with the operational surface of the solar collector 202 facing upwards towards the top portion of the pedestal 204.

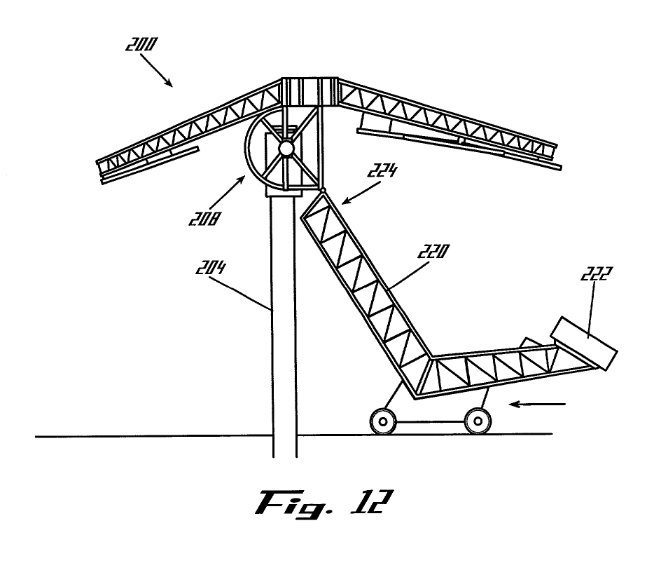

FIG. 8 illustrates the solar collector 202 near the top portion of the pedestal 204. Once the pedestal jacking device 206 lifts the azimuth collar 216 with the solar collector 202 near the top portion of the pedestal 204, the azimuth collar 216 and the solar collector 202 can be secured into position at the top portion of the pedestal 204. After the azimuth collar 216 and solar collector 202 are secured near the top of the pedestal 204, the azimuth/elevation drive apparatus 208 can be engaged to rotate the solar collector 202 into an operational or stowed position.

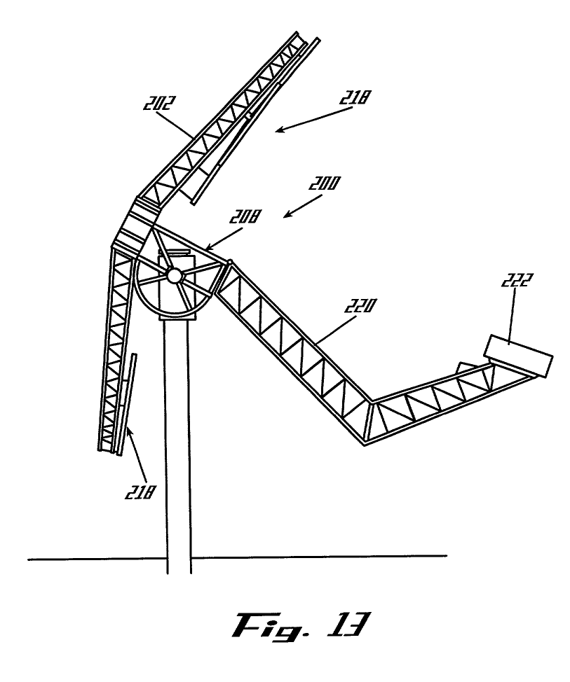

FIG. 9 shows the solar collector 202 rotating from a substantially horizontal, face up position towards a substantially vertical, upright position. Once activated, the azimuth/elevation drive apparatus 208 begins to rotate the solar collector 202 from an initial substantially horizontal, face up position towards a substantially vertical, upright position and then eventually towards a horizontal, face down or stowed position.

FIG. 10 illustrates the solar collector 202 rotating from a substantially vertical, upright position towards a substantially horizontal, face down or stowed position. The azimuth/elevation drive apparatus 208 continues to rotate the solar collector 202 from an initial substantially horizontal, face up position past a substantially vertical, upright position and then eventually to a substantially horizontal, face down or stowed position.

FIG. 11 illustrates the solar collector 202 in a horizontal, face down or stowed position. When the azimuth/elevation drive apparatus 208 completes the rotation of the solar collector 202, the solar collector 202 is now in a substantially horizontal, face down or stowed position. In the face down or stowed position, the solar collector 202 will be facing the lower portion of the pedestal 204 or the ground. In this position, an operational surface 218 of the solar collector 202 can be protected from environmental elements such as rain, hail, and other types of falling or wind-borne objects.

FIG. 12 shows a power conversion support arm 220 being attached to the solar collector 202. A power conversion support arm 220 is an associated component part of the solar collector system 200. The power conversion support arm 220 also connects to the stirling engine/generator 222 that can be transported to the installation site of the solar collector 202 on a trailer or similar type of transport device for transporting the power conversion support arm 220 and stirling engine/generator 222 assembly. When the power conversion support arm 220 is moved into a position adjacent to the solar collector 202, an upright end 224 of the arm 220 can be connected to the solar collector 202 already mounted on the pedestal 204. When the power conversion support arm 220 and stirling engine/generator 222 are connected to the azimuth/elevation drive apparatus 208, the solar collector system 200 is fully assembled and capable of converting solar energy into usable electrical power.

FIG. 13 illustrates the solar collector system 200 including the solar collector 202, power conversion support arm 220, and stirling engine/generator 222 being rotated to an operational position. After the power conversion support arm 220 and stirling engine/generator 222 are connected to the azimuth/elevation drive apparatus 208 to complete the assembly of the solar collector system 200, the azimuth/elevation drive apparatus 208 rotates the solar collector 202, power conversion support arm 220, and stirling engine/generator 222 to an operational position. An operational position is when the operational surface 218 of the solar collector 202 is rotated from a substantially horizontal, face down position to a position where the operational surface of the solar collector 202 is ready to focus solar energy onto the stirling engine/generator 222.

FIG. 14 shows the solar collector system 200 in an operational position. In the operational position, the operational surface 218 of the solar collector 202 is ready to focus solar energy onto the stirling engine/generator 222 in order to create usable electrical power.

Pedestal Jacking Device

As shown in FIG. 6, the pedestal 204 is mounted with the solar collector 202 at the bottom of the pedestal 204. In order to operate the solar collector system 200, the solar collector 202 must be elevated to the operating level, or top portion of the pedestal 204. The height of the pedestal 204 may typically range from 10 to 30 feet, but is preferably twenty six feet high. The solar collector 202 typically weighs approximately 10,000 pounds, making the elevation of the solar collector 202 from ground level to operating level a significant task.

The pedestal jacking device 206 elevates the solar collector 202 and azimuth/elevation drive apparatus 208 along the pedestal 204. The pedestal jacking device 206 comprises an azimuth collar 216, configured around the pedestal 204 and attached to the solar collector 202. In one embodiment of the invention, as shown in FIGS. 15-17, a pedestal jacking device 300 is shown. The pedestal jacking device 300 is driven by a threaded rod assembly 302. An azimuth collar 304 has a top rim 306 which encircles the pedestal 308. The top rim 306 has a flange 310 which extends radially outward from the pedestal 308. A pair of threaded rods 312 extend upwardly from the flange 310 to the top portion of the pedestal 308 where they each pass through a nut 314. The threaded rods 312 are located on opposite sides of the rim 306, diametrically opposed to one another. The threaded rods 312 are approximately 1.25 inches in diameter and of sufficient length to extend from the top of the azimuth collar 304 positioned at ground level through the nut 314 located at the top portion of the pedestal 308. This length is preferably between ten and thirty feet long. Each nut 314 is located at the top portion of the pedestal 308. Because the threaded rods 312 are located adjacent to the cylindrically-shaped pedestal 308, the nuts 314, which are vertically aligned with the threaded rods 312, are located adjacent the top portion of the pedestal 308.

FIGS. 15-17 also illustrate a method of elevating the solar collector 202 and azimuth/elevation drive apparatus 208 from the ground level to the operating level using a pedestal jacking device 300. In order to elevate the solar collector 202 and azimuth/elevation drive apparatus 208 from the ground level to the operating level as shown in FIGS. 6-8, the pedestal jacking device 300 of FIGS. 15-17 can be activated. An electric motor (not shown) located at the top portion of the pedestal 308 is energized using an external power source (not shown) and standard switch (not shown). The electric motor operates to turn the nuts 314 in a first direction, depending on the spiral thread of the threaded rods 312, which forces the threaded rods 312 upward through the nuts 314. The grooves of the nuts 314 pass along the spiral thread of the rods 312, causing this upward movement as shown in FIGS. 15-17. As the threaded rods 312 pass upwardly through the nuts 314, the attached azimuth collar 304, solar collector (shown in FIGS. 6-8 as 202), and azimuth/elevation drive apparatus (shown in FIGS. 6-8 as 208) are also raised. It is preferable that the nuts 314 are turned at the same speed and are mechanically synchronized to achieve balanced lifting of the solar collector 202 and the azimuth/elevation drive apparatus 208.

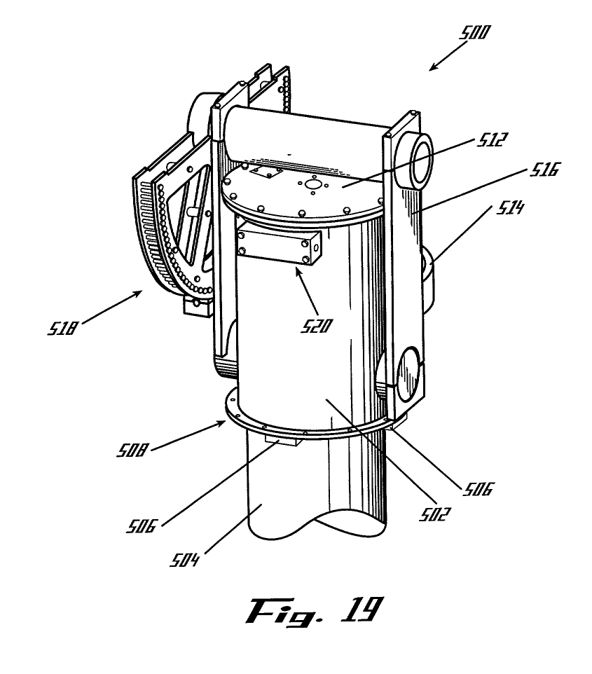

The electric motor continues to turn the nuts 314, raising the azimuth collar 304, solar collector 202, and azimuth/elevation drive apparatus 208, until the top rim 306 of the collar 304 meets the nuts 314 as shown in FIG. 17. At this point, the solar collector 202 is at an operating level as shown in FIG. 8. The threaded rods 312 extend upward beyond the top portion of the pedestal 308. The pedestal jacking device 300 works equally well by placing the turning nuts 314 on the bottom of the threaded rods 312 connected to the azimuth/elevation drive apparatus 208, so that the pedestal jacking device 300 crawls up the rods 312 as the rods 312 move downward through the nuts 314.

The azimuth collar 304 is locked into place at the top portion of the pedestal 308, by attaching the collar 304 to a top azimuth plate 316 located at the top portion of the pedestal 308. The azimuth collar 304 is connected to the top azimuth plate 316 by screws (not shown) which are passed through corresponding screw holes in the top azimuth plate 316. The top plate 316, which rests on a bearing (not shown), is automatically indexed to properly align the screw holes of the top azimuth plate 316 with corresponding screw holes located in the top rim 306 of the azimuth collar 304. The screws are passed through the top plate 316 and engage the azimuth collar 304. The screws may be fastened manually or by an automated mechanism. If the screws are to be fastened manually, it may be necessary to access the top portion of the pedestal 308 using a ladder (not shown), climbing the pedestal 308 or some other elevating device, such as a man lift or basket.

The azimuth collar 304, solar collector 202, and azimuth/elevation drive apparatus 208 may be lowered at any time. This is convenient if repairs are necessary to the solar collector 202, such as replacing operational surface such as a broken solar panel due to hail or wind damage. To lower the pedestal jacking device 300, the screws attaching the top azimuth plate 316 to the azimuth collar 304 are removed. This can be performed either manually or by automation. The elevation torque shaft (not shown) may then need to be offset from the pedestal to clear the pedestal. The electric motor is then activated in a reverse fashion, turning the nuts 314 in the opposite direction from the lifting sequence. The threaded rods 312 pass through the nuts 314, lowering the azimuth collar 304 and solar collector 202. The azimuth collar 304 and solar collector 202 may be lowered partially to a desired height, at which time the motor is stopped. The azimuth collar 304 and solar collector 202 may also be lowered to the ground level as shown in FIG. 6, facilitating repair procedures.

In another embodiment of the invention, a pedestal jacking device 400 comprises a hydraulic lifting device 402, as shown in FIG. 18. At the ground level, the hydraulic lifting device provides a lower clamping collar 404 located at the bottom portion of the pedestal 406. The lower clamping collar 404 encircles the pedestal 406. A clamp 408, having two aligned clamping elements 408a, 408b, extends outwardly from the clamping collar 404. A double acting hydraulic cylinder 410 is positioned horizontally between the clamping elements 408a, 408b.

A top clamping collar 412 is located on the pedestal 406, above the lower clamping collar 404, and also encircles the pedestal 406. The top clamping collar 412 is preferably located approximately two feet above the lower clamping collar 404. A clamp 414, having two aligned clamping elements 414a, 414b, extends outwardly from the top clamping collar 412. A double acting hydraulic cylinder 416 is positioned horizontally between the clamping elements 414a, 414b. Vertically oriented double acting hydraulic cylinders 418 connect the lower clamping collar 404 to the top clamping collar 412. It is preferable to have four vertically oriented hydraulic cylinders 418, although fewer or more may be used.

An azimuth collar 420 attaches to the top clamping collar 412 and extends upward, around the pedestal 406. The azimuth/elevation drive apparatus (shown in FIGS. 6-8 as 208) and solar collector (shown in FIGS. 6-8 as 202) are attached to the azimuth collar 420. A flange 422 extends from the top rim 424 of the azimuth collar 420.

In order to elevate the solar collector 202 and azimuth/elevation drive apparatus 208 from the ground level to operational level as shown in FIGS. 6-8, each of the double acting hydraulic cylinders 410, 416 are connected to a hydraulic motor (not shown) drawing current from a power source (not shown). The vertical hydraulic cylinders 418 are shown here in an extended position. The cycle starts with vertical hydraulic cylinders 418 in the retracted position. Once the power source is activated, the clamp 414 located on the top clamping collar 412 is released by extending the horizontal hydraulic cylinder 416. Hydraulic pressure is applied to the horizontal hydraulic cylinder 410 which extends the horizontal hydraulic cylinder 410. The clamp 408 located on the lower clamping collar 404 is in a locked position around the pedestal 406. The vertical hydraulic cylinders 418 are extended, forcing the top clamping collar 412 upwards, preferably by approximately one foot. When the vertical hydraulic cylinders 418 are fully extended, hydraulic pressure is applied to the horizontal hydraulic cylinder 416, retracting the cylinder 416 and locking the top clamping collar 412 to the pedestal 406. The horizontal hydraulic cylinder 410 of the lower clamping collar 404 is then extended, releasing the clamp 408, freeing the lower clamping collar 404 for movement. The vertical hydraulic cylinders 418 are then retracted, pulling the lower clamping collar 404 upward approximately one foot. The horizontal hydraulic cylinder 410 of the lower clamping collar 404 is retracted using hydraulic pressure, locking the lower clamping collar 404. This completes one cycle of movement using the hydraulic lifting device 402. The horizontal hydraulic cylinder 416 of the top clamping collar 412 is released to once again raise the top clamping collar 412 by approximately one foot. This process is repeated until the azimuth collar 420 reaches the top of the pedestal 406.

Once the azimuth collar 420 reaches the top portion of the pedestal 406, it is locked by placing screws through the top plate 316, which is resting on a bearing (not shown), as described above in FIGS. 15-17. The screws engage corresponding holes located on the top of the flange 422 of the azimuth collar 420. The azimuth/elevation drive apparatus 208 and solar collector 202 are now at an operation level as shown in FIG. 8. It should be understood that the above described sequence may be reversed to lower the azimuth/elevation drive apparatus 208 and solar collector 202 to ground level as shown in FIG. 6. The hydraulic climbing mechanism 402 may operate at a speed of approximately two minutes per cycle.

The Azimuth/Elevation Drive Apparatus

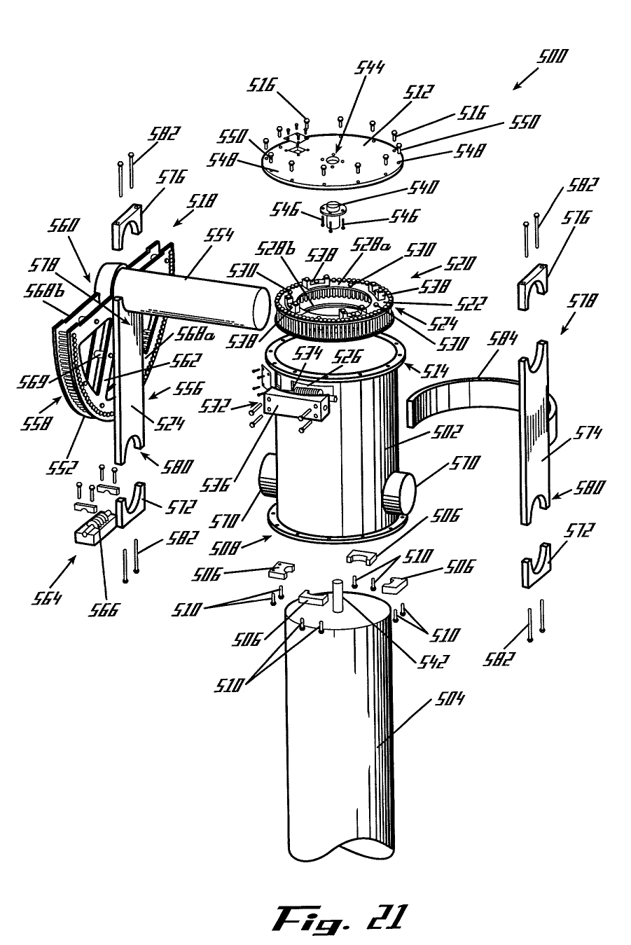

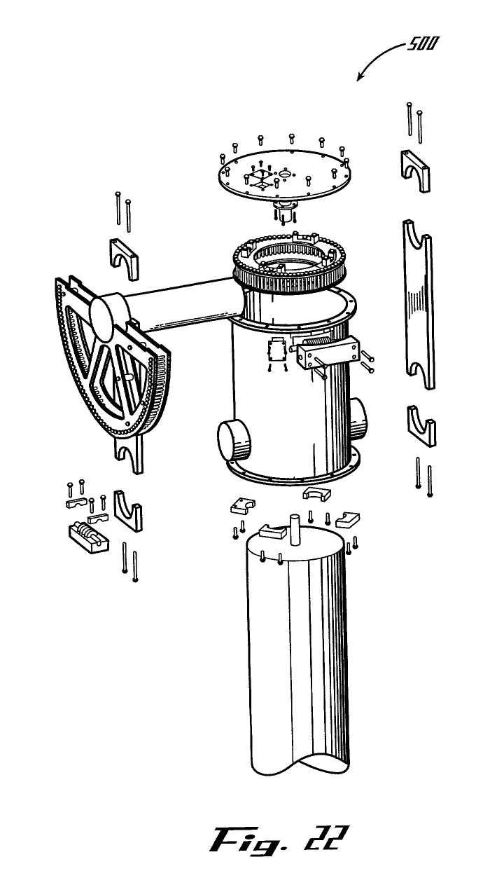

FIG. 19 illustrates an exemplary embodiment of an azimuth/elevation drive apparatus 500 according to the invention. FIG. 20 is a perspective views of the azimuth/elevation drive apparatus 500 shown in FIG. 19. FIGS. 21 and 22 are exploded views of the azimuth/elevation drive apparatus 500 shown in FIG. 19. The azimuth/elevation drive apparatus 500 is a versatile and relatively inexpensive, simple design that does not require complex linkages or expensive gearing. The azimuth/elevation drive apparatus 500 cooperates with an azimuth collar 502 to erect a pedestal 504 in a substantially vertical position as previously shown in FIGS. 4-6. Furthermore, the azimuth/elevation drive apparatus 500 cooperates with the azimuth collar 502 to rotate the solar collector (shown in FIGS. 4-6 as 202) on the pedestal 504 when tracking the movement of the sun or another object. These features of the azimuth/elevation drive apparatus 500 demonstrate the integration of the drive apparatus 500 with the solar collector system (shown as 200 in FIGS. 4-6). Multiple uses for existing parts and assemblies of the solar collector system 200 reduce the need for additional erection equipment such as heavy lifting cranes during deployment. In remote areas where access to heavy lifting equipment is time consuming, expensive, or impractical, an azimuth/elevation drive apparatus 500 that is integrated with a solar collector 202 and pedestal 504 can minimize the time and resources necessary during deployment of the solar collector system 200.

The azimuth/elevation drive apparatus 500 supports the solar collector 202, and the azimuth/elevation drive is supported by the azimuth collar 502. When the azimuth collar 502 travels up and down the pedestal 504, the solar collector 202 and the azimuth/elevation drive apparatus 500 also move up and down the pedestal 504. The azimuth collar 502 is configured to transmit the load of the solar collector and the azimuth/elevation drive apparatus 500 to the pedestal 504. Moreover, the azimuth collar 502 is configured to distribute the load forces from the solar collector 202 in order to minimize forces on any single point along the pedestal 504.

The azimuth/elevation drive apparatus 500 is capable of handling relatively high moments. The azimuth/elevation drive apparatus 500 is configured to rotate the solar collector from a stowed position to an operational position and handle the moment forces generated by the solar collector 202 being elevated and rotated upon a pedestal 504. In another example as shown in FIGS. 12 and 13, when the power conversion arm 220 and stirling engine/generator 222 are not connected to the solar collector 202, a relatively high moment is created by the combination of the weight and configuration of the overall assembly of solar collector system 200. For example, the weight of the solar collector 202 can be approximately 10,000 pounds with approximately a twelve foot offset from the center of rotation, which is an unbalanced gravity load of approximately 1,000 square feet of operational surface 218 such as conventional solar panels. With the power conversion arm 220 and stirling engine/generator 222 in place, a total system weight of approximately 14,000 pounds is nearly balanced about the center of rotation.

As shown in FIGS. 19 and 20, the azimuth collar 502 is ring-shaped with an inner diameter and an outer diameter. Preferably, the outer diameter is approximately 36 inches, the inner diameter is approximately 32 inches, and the height of the azimuth collar 502 is approximately 50 inches. In this embodiment, the azimuth collar 502 fits concentrically around the circumference of the pedestal 504 so that the inner circumferential sides of the azimuth collar 502 maintain sliding contact with the outer circumferential sides of the pedestal 504 as the azimuth collar 502 travels along the length of the pedestal 504.

A set of bottom pedestal azimuth bearings 506 provides bearing contact between the inner circumferential sides of the azimuth collar 502 and the outer circumferential sides of the pedestal 504 as the azimuth collar 502 moves up and down the pedestal 504. The bottom pedestal azimuth bearings 506 connect to the lower portion of the azimuth collar 502 along the circumference of the bottom edge 508 of the azimuth collar 502. A set of bearing screws 510 connect the bottom pedestal azimuth bearings 506 to the azimuth collar 502. Preferably, four bottom pedestal azimuth bearings 506 are equally spaced at quarter points around the circumference of the azimuth collar 502 and bearing screws 510 secure the bearings 506 to the azimuth collar 502, however a greater or lesser number of bearings 506 can be used.

Moreover, the azimuth collar 502 is configured to be secured to a top azimuth plate 512 (also shown as 316 in FIGS. 15-17) near the top portion of the pedestal 504. For example, a set of bolt holes can be machined in the azimuth collar 502 along the circumference of the top edge 514 of the collar 502. The bolt holes can be sized to receive corresponding bolts 516 to secure the top azimuth plate 512 to the azimuth collar 502 near the top portion of the pedestal 504.

The azimuth/elevation drive apparatus 500 includes two separate drive subassemblies: an elevation drive sub-assembly 518 and an azimuth drive subassembly 520. Both the elevation drive sub-assembly 518 and the azimuth drive sub-assembly 520 are relatively inexpensive and simple designs that do not require complex linkages or expensive gearing.

The elevation drive sub-assembly 518 mounts to the exterior of the azimuth collar 502. The azimuth drive sub-assembly 520 mounts partially to the exterior of the azimuth collar 502, and is partially contained within the azimuth collar 502. The elevation drive sub-assembly 518 and the azimuth drive sub-assembly 520 are each configured to rotate the combination of the solar collector 202 with respect to at least one direction relative to the pedestal 504. For example, the elevation drive sub-assembly 518 can rotate the solar collector 202 from a substantially horizontal, face up position through a substantially vertical position and then to a substantially horizontal, face down or stowed position as shown in FIGS. 8-11. Furthermore, when the power conversion support arm 220 and the stirling engine/generator 222 are not connected to the solar collector 202, the elevation drive sub-assembly 518 can rotate the assembly from an initial installation position to an operational position as shown in FIGS. 12-14. Moreover, the azimuth drive sub-assembly 520 can rotate the solar collector 202, power conversion support arm 220, and stirling engine/generator 222 about a substantially vertical axis collinear with a vertical axis through the pedestal 504 as shown in FIG. 14. Through operation of the elevation sub-assembly 518 and azimuth sub-assembly 520, the azimuth/elevation drive apparatus 500 can track the sun or another object by moving the associated solar collector 202 when needed.

The elevation drive sub-assembly 518 includes drive components that are not required to be contained or installed inside a gear box. The drive components can be readily installed and disassembled when needed, and mount directly or indirectly to the exterior of the azimuth collar 502. This type of drive configuration reduces the time and costs of deploying a solar collector 202. In one configuration, an associated single drive motor (not shown) can be used in conjunction with a band mechanism with a radiator hose-type clamp to connect the motor to an associated elevation worm gear. In another configuration, an associated single drive motor (not shown) can be used in conjunction with a gear reduction set and chain drive to drive an associated elevation worm gear.

The azimuth drive sub-assembly 520 also includes drive components that are not required to be contained or installed inside a gear box. The drive components can be readily installed and disassembled when needed, and mount directly to the exterior of the azimuth collar 502. In one configuration, an associated single drive motor (not shown) can be used in conjunction with a conventional gear reduction set to drive an associated azimuth worm gear.

FIG. 21 is an exploded view of the azimuth/elevation drive apparatus 500 shown in FIG. 19. FIG. 22 is another exploded view of the azimuth/elevation drive apparatus 500 shown in FIG. 19. The azimuth drive sub-assembly 520 includes an azimuth drive gear 522 that is supported in a substantially horizontal position by the top portion of the pedestal 504. The azimuth drive gear 522 fits concentrically within the azimuth collar 502 and rotates within the collar 502 when the collar 502 is positioned near the top portion of the pedestal 504. Generally, the azimuth drive gear 522 is a ring-shaped piece with a set of gear teeth 524 along the outer circumference of the gear 522. An opening 526 in the lateral side of the azimuth collar permits outside access to the gear teeth 524 along the outer circumference of the azimuth drive gear 522.

Typically, a corresponding pair of ring-shaped plates 528a, 528b connect together with a series of spacer bolts 530 between the plates 528a, 528b to form an azimuth drive gear 522. Preferably, gear teeth 524 are a series of cylindrical bolt-like parts that are equally spaced apart and connected between the plates 528a, 528b. The spaced apart gear teeth 524 are sized to correspond with an associated azimuth worm gear, as described below. Conventional gear teeth or similar types of gearing can be used with the azimuth drive gear 522 and an associated azimuth worm gear.

Preferably, an azimuth drive gear 522 is approximately 30 inches in diameter. The azimuth drive gear 522 is made from two machined steel plates 528a, 528b approximately ½ inch thick. The plates 528a, 528b are spaced apart approximately 4 inches and connected by a series of spacer bolts 530 approximately 6 inches in length and 1 inch in diameter. The outer circumferential portion of each of the ring-shaped plates 528a, 528b is approximately 4 inches wide. The gear teeth 524 are approximately ¾ inches in diameter, approximately 4 inches in length, and are each spaced approximately ¾ inch apart on a 29 inch diameter bolt circle.

An azimuth worm drive assembly 532 mounts to a lateral side of the azimuth collar 502, adjacent to the opening 526 providing access to the gear teeth 524 along the outer circumference of the azimuth drive gear 522. The azimuth worm drive assembly 532 includes an azimuth worm gear 534 that engages one or more azimuth gear teeth 524 to create a crossed gear mesh drive train. That is, the shaft axis of the azimuth drive gear 522 and the shaft axis of the azimuth worm gear 534 are oriented at approximately ninety degrees to each other. The azimuth worm drive assembly 530 also includes a drive motor (not shown) that is configured to rotate the azimuth worm gear 534. Preferably, a velocity gear ratio for an azimuth worm drive assembly is approximately 1 to 60. That is, the azimuth worm gear 534 must make approximately 60 revolutions in order to revolve the azimuth drive gear 522 once.

The azimuth worm drive assembly 532 also includes an azimuth worm gear housing 536 that covers the azimuth worm gear 534 and protects the gear 534 from external elements. The azimuth worm gear housing 536 mounts to the exterior surface of the azimuth collar 502 and permits an exposed shaft end of the azimuth worm gear 534 to extend or protrude through the side of the housing 536. An associated drive motor (not shown) can be connected to the exposed shaft end of the azimuth worm gear 534 by a conventional drive connection.

The top portion of the azimuth worm drive assembly 532 includes a set of top plate bearing assemblies 538 and a top pedestal azimuth bearing 540 that are configured for bearing contact with the bottom side of the top azimuth plate 512 (also shown as 316 in FIGS. 15-17). The top plate bearing assemblies 538 mount to quarter points on the top portion or plate 528a of the azimuth drive gear 522. When the azimuth drive gear 522 is positioned on the top end of the pedestal 504, the top azimuth plate 512 can be aligned with the top portion or plate 528a of the azimuth drive gear 522. The top pedestal azimuth bearing 540 and the set of top plate bearing assemblies 538 establish bearing contact with the bottom side of the top azimuth plate 512, and permit the top azimuth plate 512 to rotate above the azimuth drive gear 522 and the top end of the pedestal 504 when the top azimuth plate 512 is rotated with respect to the pedestal 504.

At the top horizontal surface of the pedestal 504, a bearing pin 542 extends substantially perpendicular from the horizontal surface of the pedestal 504. The bearing pin 542 is sized to receive a portion of the top pedestal azimuth bearing 540. The top pedestal azimuth bearing 540 is configured to mount to the exposed end of the bearing pin 542 and maintain bearing contact with the bottom side of the top azimuth plate 512.

The top azimuth plate 512 is sized to cover the open exposed end of the azimuth collar 502. The top azimuth plate 512 protects the top of the azimuth drive gear 522 within the azimuth collar 502. A set of mounting holes 544 in the center portion of the top azimuth plate 512 are sized to receive corresponding mounting bolts 546 that connect the top pedestal azimuth bearing 540 to the top azimuth plate 512. When the top pedestal azimuth bearing 540 and top azimuth plate 512 are assembled to create bearing contact between the bearing 540 and the bottom side of the top azimuth plate 512, the combined assembly can mount to the exposed end of the bearing pin 542 extending from the top end of the pedestal 504.

As described previously in FIGS. 15-17, the top azimuth plate 512 includes a set of mounting holes 548 along the outer perimeter of the plate 512. The mounting holes 548 are sized to receive a set of lock bolts 550 that correspond with machined bolt holes along the circumference of the top edge (shown as a flange 422 in FIGS. 15-17) of the azimuth collar 502. In this manner, the top azimuth plate 512 can be rotated with respect to the pedestal 504 so that the set of mounting holes 548 in the top azimuth plate 512 can be aligned with the set of corresponding bolt holes in the azimuth collar 502. When the mounting holes 546 and the bolt holes are aligned, the lock bolts 550 can be inserted to secure the top azimuth plate 512 to the top edge of the azimuth collar 502.

The azimuth drive sub-assembly 518 rotates the solar collector 202 in either direction about a substantially vertical axis collinear with the pedestal 504. By securing the top azimuth plate 512 to the azimuth collar 502, the azimuth collar 502 and solar collector 202 can be rotated at the same time. When activated, the drive motor (not shown) of the azimuth drive sub-assembly 520 turns the exposed shaft end of the azimuth worm gear 532 inside the housing 534. The azimuth worm gear 532 engages one or more gear teeth 524 of the azimuth drive gear 522 to rotate the azimuth drive gear 522 inside the azimuth collar 502 and atop the pedestal 504. In turn, the azimuth drive gear 522 rotates the solar collector 202 mounted to the azimuth/elevation drive apparatus 500. It should be noted that by removing four or more consecutive azimuth gear teeth 524, the azimuth drive subassembly 518 becomes incapable of rotating 360 degrees. This makes the azimuth drive sub-assembly 518 inherently safe, without the use of limit switches to limit rotation.

The elevation drive sub-assembly 518 rotates the solar collector 202 from a face-up position to a face-down position as shown in FIGS. 8-11. The elevation drive sub-assembly 518 includes an elevation drive gear 552 that is supported in a substantially vertical position near one end of an elevation torque shaft 554. The elevation torque shaft 554 is supported in a substantially horizontal position by a pair of multi-piece pivot mounts 556 connected to opposing exterior sides of the azimuth collar 502. The ends of the elevation torque shaft 554 are configured to connect to opposing halves of the solar collector 202 so that each end of the elevation torque shaft 554 supports at least one half of the load of the solar collector 202. When the elevation drive gear 552 is rotated, the elevation torque shaft 554 and the solar collector 202 rotate in a corresponding direction.

The elevation drive gear 552 is a semi-circular shaped gear with a set of gear teeth 558 oriented at an inset position along the circumference of the rounded portion of the drive gear 552. Typically, the elevation drive gear 552 is oriented such that the rounded portion faces downward towards the lower portion of the pedestal 504. The center portion of the elevation drive gear 552 includes a shaft mount 560 to receive an end of the elevation torque shaft 554. The shaft mount 560 is sized to fit around the elevation torque shaft 554. The elevation torque shaft 554 and elevation drive gear 552 can then rotate together. Radiating outward from the shaft mount 560 are four equally spaced support ribs 562 that connect to the rounded portion of the elevation drive gear. A greater or fewer number of support ribs 562 can be used. Adjacent to the rounded portion of the elevation drive gear 552, a set of gear teeth 558 are inset along the circumference of the rounded portion to expose the gear teeth 558 to an associated elevation worm drive assembly 564.

The associated elevation worm drive assembly 564 includes an elevation worm gear 566 and drive motor (not shown) that mount to a lateral side of a multi-piece pivot mount 556 and below the elevation drive gear 552. In this position, the elevation worm gear 566 engages one or more of the gear teeth 558 of the elevation drive gear 552 to create a crossed gear mesh drive train. That is, the shaft axis of the elevation drive gear 552 and the shaft axis of the elevation worm gear 566 are oriented at substantially a right angle to each other. The drive motor can be connected to the elevation worm gear 552 by a drive band with a radiator hose type clamp, a gear, a walking foot arrangement mechanism, or a ratchet and pulley combination.

Preferably, an elevation drive gear 552 is approximately 10 feet in diameter. The elevation drive gear 552 is made from two semi-circular shaped steel plates 568a, 568b approximately ⅜ inches thick. The plates 568a, 568b are spaced approximately 4 inches apart and connected by a series of connection bolts 569 approximately 6 inches in length and 1 inch in diameter. Moreover, the shaft mount 560 is approximately 12 inches in diameter, and the ribs 562 are approximately 6 inches wide. The gear teeth 558 are a series of cylindrical, bolt-like parts that are equally spaced between the plates 568a, 568b of the elevation drive gear 552. The gear teeth 558 are approximately ¾ inches in diameter and approximately 4 inches in length. The gear teeth 558 are spaced approximately ¾ inches apart.

To generate a relatively high moment capability needed to rotate a solar collector 202 as described above, a velocity gear ratio for an elevation drive subassembly 518 is approximately 1 to 250. That is, the elevation worm gear 564 must make approximately 250 revolutions in order to revolve the elevation drive gear 552 once. Furthermore, to handle the relatively high moments generated by the configuration of the solar collector 202, the multi-piece pivot mounts 556 should be spaced approximately 36 inches apart to support an elevation torque shaft 554 that is approximately 12 inches in diameter and 48 inches in length.

Each of the multi-piece pivot mounts 556 transmit and distribute the load of the solar collector 202 from the elevation torque shaft 554 down to the azimuth collar 502. The azimuth collar 502 further spreads the load across various portions of the pedestal 504. Generally, each multi-piece pivot mount 556 is a rectangularly-shaped plate that extends laterally adjacent to and along the azimuth collar 502. Each multi-piece pivot mount 556 connects to the lower portion of the azimuth collar 502 by way of a respective azimuth collar mount 570. The azimuth collar mounts 570 transfer the load from the multi-piece pivot mounts 556 to the azimuth collar 502. Each azimuth collar mount 570 is a shaft-like protrusion that extends substantially perpendicular and outward on opposing lateral sides of the lower portion of the azimuth collar 502. Preferably, the azimuth collar mounts 570 are made from steel and are approximately 6 inches in length and approximately 6 inches in diameter.

Each multi-piece pivot arm 556 includes a lower pivot bearing cap 572, a center pivot arm 574, and an upper elevation bearing cap 576. The lower pivot bearing cap 572 and the upper elevation bearing cap 576 are pillow block-type bearing halves. The center pivot arm 574 is an elongated double wrench-shaped piece that extends along the length of the azimuth collar 502. Each end 578, 580 of the center pivot arm 574 is configured with a pillow block-type bearing half, in which the upper elevation bearing cap 576 corresponds to the upper end 578 of the center pivot arm 574, while the lower pivot bearing cap 572 corresponds to the lower end 580 of the center pivot arm 574. Bearing set screws 582 are used to secure the lower pivot bearing cap 572 and the upper elevation bearing cap 576 to the respective ends 578, 580 of the center pivot arm 574. Preferably, the center pivot arm 574 is made from steel and is approximately 72 inches in length and is approximately 16 inches wide.

In this configuration, the upper end 578 of each center pivot arm 574 cooperates with a respective upper elevation bearing cap 576 to circumferentially fit around the ends of the elevation torque shaft 554 so that the elevation torque shaft 554 can be supported at the upper portion of each multi-piece pivot mount 556. Further, the lower end 580 of each center pivot arm 574 cooperates with a respective lower pivot bearing cap 572 to circumferentially fit around the extended portions of respective azimuth collar mounts 570 so that the lower portions of the multi-piece pivot mounts 556 can pivot with respect to the azimuth collar mounts 570.

The azimuth collar mounts 570 permit the multi-piece pivot mounts 556 to simultaneously pivot so that the elevation torque shaft 554 can be offset from the lengthwise axis of the pedestal 504. In this manner, the azimuth collar 502 can transport the azimuth/elevation drive apparatus 500 up and down the length of the pedestal 504 without the elevation torque shaft 554 interfering with the pedestal 504. When the elevation torque shaft 504 has cleared the top portion of the pedestal 504, the azimuth collar mounts 570 permit the multi-piece pivot mounts 556 to simultaneously pivot so that the elevation torque shaft 554 can be aligned with the lengthwise axis of the pedestal 504. In this manner, the elevation torque shaft 554 can be balanced above the pedestal 504.

Movement of the multi-piece pivot mounts 556 is synchronized by a pivot link 584. The pivot link 584 extends horizontally between the center portions of the multi-piece pivot mounts 556. The pivot link 584 is a semi-circular shaped plate that connects to both of the center pivot arms 574 of each multi-piece pivot mount 556. The pivot link 584 also circumferentially fits around a portion of the outer surface of the azimuth collar 502 and creates a physical stop for any further movement of the multi-piece pivot mounts 556 when the center pivot arms 574 are in a substantially vertical position. Therefore, the pivot link 584 coordinates the motion of the multi-piece pivot mounts 556 so that the movement of each center pivot arm 574 is uniform and the same with respect to the azimuth collar 502. Preferably, a pivot link 584 is made from steel square tubing and is approximately 14 inches wide and approximately 2 inch thick.

To operate the elevation drive sub-assembly 518, the drive motor (not shown) is activated. The drive motor rotates an exposed end of the elevation worm gear 564 in either direction. The elevation worm gear 564 engages one or more gear teeth 558 of the elevation drive gear 552 and rotates the elevation drive gear 564. As the elevation drive gear 552 rotates, the elevation torque shaft 554 and the solar collector 202 rotate in a corresponding direction.

When the solar collector 202 is to be lowered with respect to the pedestal 504, the top azimuth plate 512 can be disengaged from the azimuth collar 502 by removal of the lock bolts 516 from the azimuth top plate 512. The multi-piece pivot mounts 556 can rotate towards the pivot link 584 so that the elevation torque shaft 554 is no longer balanced above the top end of the pedestal 504. A pedestal jacking device, as shown in FIGS. 15-18, can then be used to lower the azimuth collar 502 and solar collector down the pedestal 504. It should be noted that by ending the elevation gear teeth 558 at appropriate angles, interference between parts of the solar collector 202 and the pedestal 504 can be eliminated. This prevents the solar collector 202 from rotating beyond face up vertical, or alternatively, beyond face down stow. This makes the elevation drive subassembly 518 inherently safe, without the use of limit switches to limit rotation.

Alternative embodiments will become apparent to those skilled in the art to which the invention pertains without departing from its spirit and scope. Accordingly, the scope of the embodiments of the invention is defined by the appended claims rather than the foregoing description.

I claim:

1. A method for deploying a solar collector mounted on a pedestal without using heavy lifting equipment, comprising:
mounting an azimuth/elevation drive apparatus on an azimuth collar;
connecting a solar collector to the azimuth/elevation drive apparatus;
connecting the azimuth collar to a pedestal;
elevating the pedestal into a substantially vertical position using the azimuth/elevation drive apparatus;
raising the azimuth collar and solar collector to the upper portion of the pedestal; and
rotating the solar collector with the azimuth/elevation drive apparatus to a position to collect solar energy.

2. The method of claim 1, wherein the azimuth/elevation drive apparatus comprises,
an azimuth drive sub-assembly with a gear ratio capable of handling a high moment caused by wind loads and the rotation of the solar collector on the pedestal; and
an elevation drive sub-assembly with a gear ratio capable of handling a high moment caused by wind loads, the balanced or unbalanced collector gravity loads, and the rotation of the solar collector on the pedestal.

3. The method of claim 2, wherein the azimuth drive subassembly further comprises
an azimuth drive gear connected to a collector, and configured to rotate the collector around an axis collinear with a substantially vertical axis of the pedestal; and
an azimuth linkage configured to transmit power from an associated motor to the azimuth drive gear.

4. The method of claim 2, wherein the elevation drive subassembly further comprises
an elevation drive gear configured to rotate the pedestal from a substantially horizontal position to a substantially vertical position, and further configured to rotate the solar collector from a face-down position through to a face-up position while the solar collector is near the top of the pedestal; and
an elevation linkage configured to transmit power from an associated motor to the elevation drive gear.

5. The method of claim 2, wherein the azimuth drive subassembly has a gear ratio of at least 40 to 1.

6. The method of claim 2, wherein the elevation drive subassembly has a gear ratio of at least 60 to 1.

7. The method of claim 1, further comprising
pivoting the azimuth/elevation drive apparatus so that the azimuth collar can be raised up the pedestal.

8. The method of claim 1, wherein raising the azimuth collar and solar collector to the upper portion of the pedestal further comprises, raising the azimuth collar with respect to the pedestal utilizing a pedestal jacking device.

9. The method of claim 8, wherein the pedestal jacking device comprises at least two threaded rods connected to an azimuth collar.

10. The method of claim 9, wherein the threaded rods each engage a nut adjacent to the top of the pedestal, the pedestal jacking device further comprising an electric motor turning the nuts and elevating the solar collector and azimuth/elevation drive apparatus.

11. The method of claim 8, wherein the pedestal jacking device comprises a hydraulic lifting device.

12. The method of claim 11, wherein the hydraulic lifting device comprises a first collar and a second collar connected to the pedestal, the first collar and the second collar connected by at least one hydraulic cylinder.

13. The method of claim 12, wherein the hydraulic cylinders alternate raising the first collar and the second collar one at a time.

14. The method of claim 1, wherein raising the azimuth collar and solar collector to the upper portion of the pedestal further comprises, raising the azimuth collar with respect to the pedestal utilizing a hydraulic jacking device.

15. An apparatus for deploying a solar collector on a pedestal without heavy lifting equipment comprising:
a pedestal jacking device configured to raise the solar collector from a ground level to an operational level;
an azimuth drive sub-assembly with a gear ratio capable of handling a high moment caused by the wind loads and the rotation of the solar collector on the pedestal, comprising,
an azimuth drive gear connected to a solar collector, and configured to rotate the solar collector around an axis collinear with a substantially vertical axis of the pedestal;
an azimuth linkage configured to transmit power from an associated motor to the azimuth drive gear;
an elevation drive sub-assembly with a gear ratio capable of handling a high moment caused by wind loads, the balanced or unbalanced collector gravity loads, and the rotation of the solar collector on the pedestal, comprising,
an elevation drive gear configured to rotate the pedestal from a substantially horizontal position to a substantially vertical position, and further configured to rotate the solar collector from a face-down position through to a face-up position while the solar collector is near the top of the pedestal;
an elevation linkage configured to transmit power from an associated motor to the elevation drive gear.

16. An apparatus for rotating a collector mounted on a pedestal to track an object comprising:
an azimuth drive sub-assembly with a gear ratio capable of handling a high moment caused by the wind loads and the rotation of the collector on a pedestal, comprising,
an azimuth drive gear connected to a collector, and configured to rotate the collector around an axis collinear with a substantially vertical axis of the pedestal;
an azimuth linkage configured to transmit power from an associated motor to the azimuth drive gear;
an elevation drive sub-assembly with a gear ratio capable of handling a high moment caused by wind loads, the balanced or unbalanced collector gravity loads, and the rotation of the collector on the pedestal, comprising,
an elevation drive gear configured to rotate the pedestal from a substantially horizontal position to a substantially vertical position, and further configured to rotate the collector from a face-down position through to a face-up position while the collector is near the top of the pedestal; and
an elevation linkage configured to transmit power from an associated motor to the elevation drive gear.

17. The apparatus of claim 16, wherein the azimuth drive subassembly has a gear ratio of at least 40 to 1.

18. The apparatus of claim 16, wherein the elevation drive subassembly has a gear ratio of at least 60 to 1.

19. An apparatus for deploying a solar collector and azimuth/elevation drive apparatus on a pedestal comprising:
a pedestal jacking device for elevating the solar collector and the azimuth/elevation drive apparatus from ground level to operating level;
an azimuth drive sub-assembly comprising a gear ratio capable of handling a high moment caused by wind loads and the rotation of the solar collector on the pedestal, the azimuth/elevation drive apparatus further comprising,
an azimuth drive gear connected to the solar collector, and configured to rotate the solar collector around an axis collinear with a substantially vertical axis of the pedestal;
an azimuth worm gear configured to transmit power from an associated motor to the azimuth drive gear;
an elevation drive sub-assembly with a gear ratio capable of handling a high moment caused by wind loads, the balanced or unbalanced collector gravity loads, and the rotation of the solar collector on the pedestal, the elevation drive sub-assembly comprising,
an elevation drive gear configured to rotate the pedestal from a substantially horizontal position to a substantially vertical position, and further configured to rotate the solar collector from a face-down position through to a face-up position while the solar collector is near the top of the pedestal;
an elevation worm gear configured to transmit power from an associated motor to the elevation drive gear.

20. The apparatus of claim 19, wherein the azimuth drive subassembly has a gear ratio of at least 40 to 1.

21. The apparatus of claim 19, wherein the elevation drive subassembly has a gear ratio of at least 60 to 1.

22. The apparatus of claim 19, further comprising an azimuth collar surrounding the pedestal, the solar collector and azimuth/elevation drive apparatus connected to the azimuth collar.

23. The apparatus of claim 22, wherein the pedestal jacking device comprises at least two threaded rods connected to an azimuth collar.

24. The apparatus of claim 23, wherein the threaded rods each engage a nut adjacent to the top of the pedestal, the pedestal jacking device further comprising an electric motor turning the nuts and elevating the solar collector and azimuth/elevation drive apparatus.

25. The apparatus of claim 24 wherein the motor is reversible to lower the solar collector and azimuth/elevation drive apparatus.

26. The apparatus of claim 19, wherein the pedestal jacking device comprises a hydraulic lifting device.

27. The apparatus of claim 26, wherein the hydraulic lifting device comprises a first collar and a second collar connected to the pedestal, the first collar and the second collar connected by at least one hydraulic cylinder.

28. The apparatus of claim 27, wherein the first collar and the second collar each comprise a clamp, a hydraulic cylinder attached to the clamp capable of opening and closing the clamp.

29. The apparatus of claim 28, wherein a hydraulic motor provides power to the hydraulic cylinders allowing the pedestal jacking device to elevate and lower the solar collector and the azimuth/elevation drive apparatus.

30. The apparatus of claim 28, wherein the first collar is located below the second collar and the azimuth collar is connected to the second collar.

31. The apparatus of claim 30, wherein the first collar is clamped to the pedestal while the second collar is raised by the hydraulic cylinders.

32. The apparatus of claim 31 wherein the second collar is clamped to the pedestal while the first collar is raised by the hydraulic cylinders.

33. An apparatus for deploying a solar collector on a substantially vertically oriented pedestal comprising:
an azimuth collar movably attached to the pedestal;
the solar collector attached to the azimuth collar;
a pedestal jacking device connected to the azimuth collar configured to raise the azimuth collar from a ground level to an operational level near the top of the pedestal; and
a drive apparatus attached to the azimuth collar for rotating the solar collector.

34. The apparatus of claim 33, wherein the pedestal jacking device comprises a hydraulic lifting device.

35. The apparatus of claim 34, wherein the hydraulic lifting device comprises a first collar and a second collar connected to the pedestal, the first collar and the second collar connected by at least one hydraulic cylinder.

36. The apparatus of claim 35, wherein the first collar and the second collar each comprise a clamp, a hydraulic cylinder capable of opening and closing the clamp.

37. The apparatus of claim 36, wherein a hydraulic motor provides power to the hydraulic cylinders allowing the pedestal jacking device to elevate and lower the solar collector and the azimuth/elevation drive apparatus.

38. The apparatus of claim 37, wherein the first collar is located below the second collar and the azimuth collar is connected to the second collar.

39. The apparatus of claim 38, wherein the first collar is clamped to the pedestal while the second collar is raised by the hydraulic cylinders.

40. The apparatus of claim 39, wherein the second collar is clamped to the pedestal while the first collar is raised by the hydraulic cylinders.

41. The apparatus of claim 33, wherein the pedestal jacking device comprises at least two threaded rods connected to an azimuth collar.

42. The apparatus of claim 42, wherein the threaded rods each engage a nut adjacent to the top of the pedestal, or on the azimuth collar, the pedestal jacking device further comprising an electric motor turning the nuts and elevating the solar collector and azimuth/elevation drive apparatus.

43. The apparatus of claim 33, wherein the drive apparatus comprises,
an azimuth drive sub-assembly with a gear ratio capable of handling a high moment caused by wind loads and the rotation of the solar collector on the pedestal; and
an elevation drive sub-assembly with a gear ratio capable of handling a high moment caused by wind loads, the balanced or unbalanced collector gravity loads, and the rotation of the solar collector on the pedestal.

44. The apparatus of claim 43, wherein the azimuth drive subassembly further comprises
an azimuth drive gear connected to a collector, and configured to rotate the collector around an axis collinear with a substantially vertical axis of the pedestal; and
an azimuth worm gear configured to transmit power from an associated motor to the azimuth drive gear.

45. The apparatus of claim 43, wherein the elevation drive subassembly further comprises
an elevation drive gear configured to rotate the pedestal from a substantially horizontal position to a substantially vertical position, and further configured to rotate the solar collector from a face-down position through to a face-up position while the solar collector is near the top of the pedestal; and
an elevation worm gear configured to transmit power from an associated motor to the elevation drive gear.

46. The apparatus of claim 44, wherein the azimuth drive subassembly has a gear ratio of at least 40 to 1.

47. The apparatus of claim 45, wherein the elevation drive subassembly has a gear ratio of at least 60 to 1.

48. The apparatus of claim 43, further comprising
a pivot mount for the offsetting the drive apparatus so that the azimuth collar can be raised up the pedestal.

49. A method for deploying a solar collector mounted on a substantially vertically oriented pedestal, comprising:
mounting an azimuth/elevation drive apparatus on an azimuth collar, the azimuth/elevation drive apparatus capable of rotating the solar collector to a position for optimum collection of sun light;
connecting the solar collector to the azimuth/elevation drive apparatus;
connecting the azimuth collar to a pedestal; and
raising the azimuth collar and solar collector to the upper portion of the pedestal using a pedestal jacking device.

50. The method of claim 49, wherein the azimuth/elevation drive apparatus comprises,
an azimuth drive sub-assembly with a gear ratio capable of handling a high moment caused by wind loads and the rotation of the solar collector on the pedestal; and
an elevation drive sub-assembly with a gear ratio capable of handling a high moment caused by wind loads, the balanced or unbalanced collector gravity loads, and the rotation of the solar collector on the pedestal.

51. The method of claim 50, wherein the pedestal jacking device comprises at least two threaded rods connected to an azimuth collar.

52. The method of claim 51, wherein raising the azimuth collar and solar collector comprises turning a plurality of nuts in a first direction using an electrical motor, each nut attached to a threaded rod and located adjacent the top of the pedestal.

53. The method of claim 49, wherein the pedestal jacking device comprises a hydraulic lifting device.

54. The method of claim 53, wherein the hydraulic lifting device comprises a first collar and a second collar connected to the pedestal, the first collar and the second collar connected by at least one hydraulic cylinder.

55. The method of claim 54, wherein the hydraulic cylinders alternate raising the first collar and the second collar one at a time.
